(19) United States
(12) Patent Application Publication
(10) Pub. No.: US 2025/0021090 A1
(43) Pub. Date: Jan. 16, 2025

(54) Monitoring of complex systems

(71) Applicant: ODYSIGHT.AI LTD., Omer (IL)

(72) Inventors: Jacob AVINU, Netiv Hashayyara (IL); Alexander KUSHNIRSKY, Nesher (IL); Eyal MADAR, Tel-Aviv (IL)

(21) Appl. No.: 18/768,641

(22) Filed: Jul. 10, 2024

Related U.S. Application Data
(60) Provisional application No. 63/578,424, filed on Aug. 24, 2023.
(60) Provisional application No. 63/513,014, filed on Jul. 11, 2023.

(51) Int. Cl. G05B 23/02

(52) U.S. Cl. CPC G05B 23/0283; G05B 23/027

(57) ABSTRACT

A monitoring system and respective method are presented. The monitoring system comprising: at least one processor and memory circuitry and VO interface adapted to receive at least two input data pieces comprising at least a first input data piece indicative of actuator operation, and at least a second input data piece indicative of a selected object's response to said actuator operation. The at least one processor is adapted for processing said at least two input data pieces and to determine data indicative of health of at least one of said selected object or said actuator.

### CROSS REFERENCE TO RELATED APPLICATIONS

This application claims the benefit of priority of U.S. Provisional Patent Application Nos. 63/513,014, filed Jul. 11, 2023 and 63/578,424, filed Aug. 24, 2023, the contents of which are all incorporated herein by reference in their entirety.

### TECHNICAL FIELD

The present disclosure, in some embodiments, thereof, relates to monitoring complex systems, and, more particularly, but not exclusively, to monitoring a system comprising of at least one actuator and at least one object or system operated by the actuator.

### BACKGROUND

Machine maintenance is important in many fields, including manufacturing, aeronautics, vehicles, and many others. Effective maintenance strategies may help prevent failures, enable organizations to meet production schedules, minimize costly downtime, and lower the risk of accidents and injuries.

Machine maintenance may include any work that maintains the mechanical assets running with minimal downtime to the machine and/or the component. Maintenance may also include replacement or realignment of parts that are worn, damaged, or misaligned.

Currently, industrial maintenance is typically scheduled for set periods of time (periodic maintenance), possibly based on factors such as statistical and/or historic data and/or a level of use (for example mileage or the number of hours in operation). Maintenance may also be performed when a machine, part or component fails (breakdown maintenance). This type of maintenance is often wasteful and inefficient.

Actuators are essential components utilized in numerous industries, ranging from robotics and aerospace to automotive and industrial automation. They play a pivotal role in transforming input energy into mechanical motion, thereby enabling controlled movement of objects or systems. Actuators are extensively employed in diverse applications, such as positioning mechanisms, valves, robotic manipulators, and many more.

Actuator movement is typically achieved through control signals that dictate the desired position, speed, and acceleration. Various control methods are employed based on the application requirements. These methods include open-loop control, closed-loop control (feedback control), and intelligent control systems utilizing sensors, microcontrollers, and algorithms to ensure accurate and precise movement control.

Despite their importance and widespread use, actuators are susceptible to various failure modes that can hinder their performance and compromise system integrity. These failure modes may include mechanical wear, electrical faults, leakage, overheating, control system malfunctions, and environmental factors.

### SUMMARY OF THE INVENTION

To enhance reliability in operation of actuator-object and general complex systems, it is crucial to identify potential failure modes and develop appropriate mitigation strategies. Often, manual inspection and monitoring of these elements is performed by technician or other maintenance personnel during idle time. Other techniques utilize separate monitoring of different elements, such as actuator monitoring and monitoring of the controlled object separately. However, in some cases it is critical that the elements monitored automatically and in real-time (e.g., during operation of the machine or system), to ensure proper function of the machines or systems and to prevent failure of the machine or systems. Accordingly, there is a need in the art to monitor complex and other mechanical systems for detection of wear/fault and/or potential failure. The present disclosure provides a system and corresponding method suitable for monitoring operation of a system and providing indication on health and/or potential failure and fault of the system. The system and method of the present disclosure may utilize combined monitoring of at least one actuator and controlled object providing robust detection suitable for various system arrangements.

The present disclosure provides a system and corresponding method for monitoring operation of a complex, e.g., mechanical system, in which at least one actuator is operable for causing selected movement of at least one object. The system is configured to receive or obtain input data comprising at least a first input data indicative of operation of the actuator and at least a second input data indicative of response of a selected object to operation of the actuator. The system further operates for processing the input data and for determining a relationship between the actuator's operation and response of the at least one object. In some embodiments, the system may determine data on quality of response of the at least one object with respect to operation of the actuator.

Generally, small variations in response of the object to actuator's operation may provide early signs of wear or fault that may lead to failure of system operation. For example, the actuator may include a motor operable to generate lateral shift of a moving arm to a predetermined distance in response to certain rotation of the motor. Variation in a ratio between rotation of the motor and movement of the object may indicate fault in one or more of the actuators, the moving arm controlled by the actuator and/or one or more interfaces between the object and actuator. The system of the present disclosure may be configured to obtain (sensing) data on operation of one or more actuators or components thereof and on response of one or more objects, and to process the (sensing) data to determine a relationship between actuator's operation and object's response, or use pre-stored or pre-provided data on relation between actuator input and output. Such sensing data may be visual data on operation, location sensing, input/output electrical signals, vibration data or any other data type that indicates operation of the actuator and/or the object. The system may analyze the determined relationship to determine data indicative of health of said selected object and said actuator. In some embodiments, the system may analyze the determined relationship based on pre-stored data on expected transfer function of the object to certain actuator operation. In some embodiments, the system may determine a transfer function indicative of object response to one or more different actuator operations.

Typically, the system may generate output data indicative of quality of the determined relationship with respect to expected transfer function, providing indication of health of the monitored system. If quality of the determined relationship, indicative of response of the object to actuator's operation is outside a selected threshold/limit with respect to expected response, the system may generate an alert indicating that the monitored system may need maintenance or require fixing. In some embodiments, the system may also determine and provide output data indicative of trend of variation of the determined relationship, providing data on possible failure modes. This may be used to determine data on what and where an expected failure may occur. It should be noted that the term “transfer function” according to some embodiments is to be understood broadly and may be viewed as a relation between input to a system, such as input operational signals to the actuator or actuator operation, and output of the system, such as response action of the controlled object. For example, the relation may be determined as output divided by input. However, a transfer function may be multi-dimensional and may be considered as any relation between input (input signal to actuator and/or actuator operation) and output being movement/response of the controlled object.

In some embodiments, input data indicative of object's movement may refer to any type of data collected by one or more sensors and indicative of location and/or variation in location or rotation of the object. The second input data piece may comprise one or more images, sensor output, etc. For example, the second input data piece may comprise output of a location/range sensor, output of a pressure sensor, and/or output of one or more optical sensors. A single image may be used for illustrating final position of the object following selected actuation. Alternatively, two or more images may illustrate one or more movement parameters of the object such as movement from an initial position to a final position, speed of movement, acceleration, direction of movement, frequency of repeating movement, etc.

Further, in some embodiments, input data indicative of operation of the at least one actuator may comprise data about operational instructions (e.g., electronic signal) transmitted to the at least one actuator to operate the actuator accordingly. Additionally, or alternatively, the input data indicative of operation of the at least one actuator may comprise one or more images indicative of actuator operation.

The system of the present disclosure may comprise one or more processor and memory circuitry (PMC), operatively connected to input and output I/O. The PMC is configured to provide processing needed for operation of the system in accordance with the present disclosure. The PMC may comprise pre-stored computer readable instructions that when executed thereby, cause the processor to perform selected processing functions. Further, in some embodiments, the PMC may periodically store data for later use. In some embodiments, The PMC may transmit data for processing on a remote one or more processors, e.g., to provide cloud processing.

Generally, embodiments of the present invention utilize monitoring (e.g., continuous monitoring) of relationship between operation of an actuator and response of a controlled object operable by the actuator. Certain embodiments involve utilizing or determining a transfer functions indicative of the object's response, and operating to determine variations from the transfer functions. In accordance with determined variations, methods and systems of the present disclosure may operate to identify one of more trends indicative of certain expected failure, prior to mechanical failure of the actuator, object and/or interface between them. Further, in some embodiments, the system may operate to determine trend of variation in object's response, providing data indicative of expected progress toward failure and/or data on failure trend.

The present disclosure provides for determining failure mode, trend of failure and/or any variation from expected response of the controlled object to operation of an actuator controlling said object. For example, in some embodiments, the system of the present disclosure may determine one or more separable failure modes relating to movement/operation of the controlled object, and indicate within output data health indicator for different failure modes, and optionally, data on variation of the health indicator, providing data on progress of variation in response of the controlled object to actuator operation.

In accordance with description herein, the monitoring system according to some embodiments of the present disclosure may be operated for determining potential fault, failure mode, trend of failure mode, and possibility of failure of a system.

As used herein, according to some embodiments, the term “fault” may refer to an anomaly or undesired effect or process in the actuator and/or controlled object and/or one or more interfaces between the object and actuator that may or may not develop into a failure. A fault may require follow-up, for example to analyze whether any components should be repaired or replaced.

According to some embodiments, the fault may include, among others, lack of alignment, improper response to an applied force or when a force is not applied, structural deformation, surface deformation, a crack, crack propagation, a defect, bending, wear, corrosion, leakage, a change in color, a change in appearance, change in pattern and the like, or any combination thereof.

According to some embodiments of the present disclosure, the term “failure” may refer to any problem that may cause the actuator and/or controlled object and/or one or more interfaces between the object and actuator to not operate as intended. In some cases a failure may disable the actuator and/or controlled object and/or one or more interfaces between the object and actuator or even pose a danger to a mechanism or user.

The term “failure mode” according to some embodiments may relate to any manner in which a fault or failure may occur, such as structural deformation, surface deformation, a crack, crack propagation, a defect, bending, wear, corrosion, leakage, a change in color, a change in appearance, turbulence, bubbles in a liquid, and the like, or any combination thereof. It is appreciated that a mechanism may be subject to a plurality of failure modes, related to different characteristics or functionalities thereof.

Further, the terms “fault trend”, or “fault deterioration trend” or the like according to some embodiments is to be widely construed to cover any behavior over time of a fault, or a failure mode, when or under what circumstances the fault will turn into a failure. The trend is optionally associated with additional circumstances such as environmental conditions, usage characteristics of the device, characteristics of a user of a device, or the like. In some embodiments, the system may further determine fault severity, relating to an “amount” of the fault in a part, or how far toward failure is the fault's progression. Fault severity may be minor, small, medium, large, critical etc. Optionally, fault severity may be classified using numerical values, such as a value between 1-10 etc. in other embodiments, fault severity may be classified using color classification, e.g., red standing for severe fault, green for a minor yet uncritical fault, yellow standing for intermediate classifications.

Accordingly, determining a fault trend may be used to determine when and under what operation type and/or environmental parameters a failure may occur. This may be used to calculate and anticipate when a failure may happen and optionally generate alert prior to occurrence of a failure and/or providing a maintenance schedule to prevent a failure. Further, certain faults may not directly relate to expected failure, but indicate general state of the system providing an indication on health of the system and/or on environmental parameters causing the fault.

Thus, according to a broad aspect of embodiments of the invention, the present disclosure provides a monitoring system comprising:

at least one processor and memory circuitry and I/O interface adapted to receiving at least two input data pieces comprising at least a first input data piece indicative of actuator operation, and at least a second input data piece indicative of a selected object's response to said actuator operation; said at least one processor is adapted for processing said at least two input data pieces and to determine data indicative of health of at least one of said selected object or said actuator.

In some embodiments, the monitoring system is suitable for monitoring of a system having at least one actuator and at least one controlled object, where the at least one actuator is operable for actuating said at least one controlled object between at least first and second states.

According to some embodiments, the at least one processor may be adapted for processing said at least two input data pieces and to determine data indicative of relationship between said selected object's response and said actuator operation, and determine data indicative of health of said selected object or said actuator in accordance with quality of relationship.

According to some embodiments, the at least one processor may be adapted for determining said data indicative of health of said selected object or said actuator based on said relationship between said selected object's response and said actuator operation, and wherein said data indicative of health comprises an alert if health of said selected object or said actuator is below a selected threshold.

According to some embodiments, the second input data piece may comprise one or more images indicative of said selected object's response to said actuator operation, said at least one processor is adapted for processing said one or more images to determine mechanical response of said selected object to said actuator operation.

According to some embodiments, the at least one processor may be adapted for determining based on said first input data piece data on desired response of said selected object.

According to some embodiments, the at least one processor may be adapted for determining based on said second input data piece data on one or more motion parameters of said selected object in response to said actuator operation.

According to some embodiments, the one or more motion parameters may comprise: range of motion, motion speed, acceleration, or motion direction of said selected object.

According to some embodiments, the at least one processor may be adapted to determine said data indicative of health of said selected object in accordance with a relation between said desired response and said one or more parameters of said selected object in response to said actuator operation.

According to some embodiments, the first input data piece may comprise one or more images indicative of operation of said actuator.

According to some embodiments, the first input data piece may comprise operation data indicative of signal transmitted to said actuator and configured to cause operation thereof.

According to some embodiments, the at least one processor may be adapted for determining a transfer function being indicative of a relation between actuator operation and response of the selected object to said actuator operation, and to store data indicative of said transfer function in said memory, and for using stored data on the transfer function to determine variation in response of said object to said actuator operation.

According to some embodiments, in response to determining said data indicative of health said selected object and said actuator being below said selected threshold, said at least one processor may be further adapted for determining an updated transfer function, and for determining output instructions indicative of corrected operation of said actuator providing a desired response of said selected object.

According to some embodiments, the at least one processor may be configured for processing data on a relationship between said selected object's response and said actuator operation and if said relationship varies from a desired transfer function, said at least one processor is adapted for generating alert indication associated with one or more failure modes.

According to some embodiments, the one or more failure modes may comprise one or more failure types selected from the group of: corrosion, tear, crack, leakage, ice accumulation, structural deformation, surface deformation, corrosion, structural defects, mechanical defects, and flutter.

According to some embodiments, the system may further comprise at least one sensor connectable to said input module and configured to provide sensing data indicating of at least one of said first or second input data pieces.

According to some embodiments, the system may further comprise at least one optical sensor connectable to said input module and configured to provide image data comprising one or more images being at least one of said first or second input data pieces.

According to some embodiments, the system may be configured to be associated with a complex system comprising at least one actuator and at least one object operatively connected to said at least one actuator such that operation of said at least one actuator causes a desired movement of said at least one object, and wherein said monitoring system and operable for generating one or more alerts in response to detection of quality of response being below a selected threshold.

According to some embodiments, the system may further be configured to determine a transfer function indicative of response of said at least one object to operation of said at least one actuator, determining an updated transfer function upon determining variation in response of said at least one object, and for generating output data indicative of updated operation instructions for operation of said at least one actuator in accordance with said updated transfer function.

According to some embodiments, the data indicative of health of said selected object and said actuator may comprise an output signal indicative of at least of: indication of a need for system maintenance, maintenance instructions, indication of system failure, indication on updated actuator operation scheme.

According to one other broad aspect, the present disclosure provides a method for monitoring a complex system, comprising:
a. providing first input data indicative of operation of at least one actuator and second input data indicative of response of at least one object actuated by said at least one actuator;
b. processing said input data and determining data indicative of a relationship between response of said at least one object and operation of said actuator;
c. generating an output signal comprising at least one indicator of health of said selected object and said actuator.

According to some embodiments, the method may comprise determining data on quality of response based on said relationship between said selected object's response and said actuator operation, and wherein said indicator comprises an alert if said quality of response is below a selected threshold.

According to some embodiments, said processing may comprise determining a transfer function indicative of a relation between actuator operation and response of the selected object to said actuator operation, and to store data indicative of said transfer function in said memory, and for using stored data on the transfer function to determine variation in response of said object to said actuator operation.

According to some embodiments, the method may further comprise processing data on said relationship between response of said at least one object and operation of said actuator and determining quality of response indicative of a variation of said relationship from a desired transfer function, determining an updated transfer function and generating output instructions indicative of corrected operation of said actuator providing a desired response of said selected object.

According to some embodiments, the method may further comprise processing data on said relationship between said selected object's response and said actuator operation and in response to determining that quality of response of said selected object being different tant from a desired transfer function, generating an alert indication associated with one or more failure modes.

According to some embodiments, said one or more failure modes may comprise one or more failure types selected from the group of: corrosion, tear, crack, leakage, ice accumulation, structural deformation, surface deformation, corrosion, structural defects, mechanical defects, and flutter.

According to some embodiments, said second input data may comprise one or more images of said at least one object.

According to some embodiments, said processing may comprise analyzing said one or more images of said at least one object for determining response of said at least one object to operation of said at least one actuator.

According to some embodiments, said determining response of said at least one object may comprise determined one or more motion parameters comprising at least one of: range of motion, motion speed, acceleration, and motion direction of said at least one object.

According to some embodiments, said first input data may comprise one or more images indicative of operation of at least one actuator.

According to some embodiments, said first input data may comprise operation data indicative of signal transmitted to said actuator and configured to cause operation thereof.

According to some embodiments, said indicator of quality of response may comprise an output signal indicative of at least of: indication of a need for system maintenance, maintenance instructions, indication of system failure, indication on updated actuator operation scheme.

According to yet another broad aspect, the present disclosure provides a program storage device readable by machine, tangibly embodying a program of instructions executable by the machine to perform a method comprising:
a. providing first input data indicative of operation of at least one actuator and second input data indicative of response of at least one object actuated by said at least one actuator;
b. processing said input data and determining data indicative of a relationship between response of said at least one object and operation of said actuator;
c. generating an output signal comprising at least one indicator of quality of response of said at least one object to operation of said at least one actuator.

According to a further aspect, the present disclosure provides a computer program product comprising a computer useable medium having computer readable program code embodied therein, the computer program product comprising computer readable program code for causing the computer to:
a. provide first input data indicative of operation of at least one actuator and second input data indicative of response of at least one object actuated by said at least one actuator;
b. process said input data and determining data indicative of a relationship between response of said at least one object and operation of said actuator;
c. generate an output signal comprising at least one indicator of quality of response of said at least one object to operation of said at least one actuator.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the invention, unless otherwise indicated. In the drawings like reference numerals are used to indicate corresponding parts.

In block diagrams and flowcharts, optional elements/components and optional stages may be included within dashed boxes.

In the figures:

FIG. 1 exemplifies a complex system and a monitoring system according to some embodiments of the present disclosure;

FIG. 2 exemplifies a complex system and a monitoring system obtaining data from controller of the complex system according to some embodiments of the present disclosure;

FIGS. 3A to 3C exemplify three images of a moving object and illustrating determining movement parameters based on image data;

FIGS. 4A and 4B illustrate schematically monitoring system according to some embodiments of the present disclosure, FIG. 4A illustrates a system configured to obtain input data from external sensors, and FIG. 4B illustrates a system including sensors;

FIG. 5 exemplifies a monitoring system according to some embodiments, in communication with one or more external systems for performing selected operations; and

FIGS. 6 and 7 are simplified flowcharts describing a method for monitoring according to some embodiments of the present disclosure.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

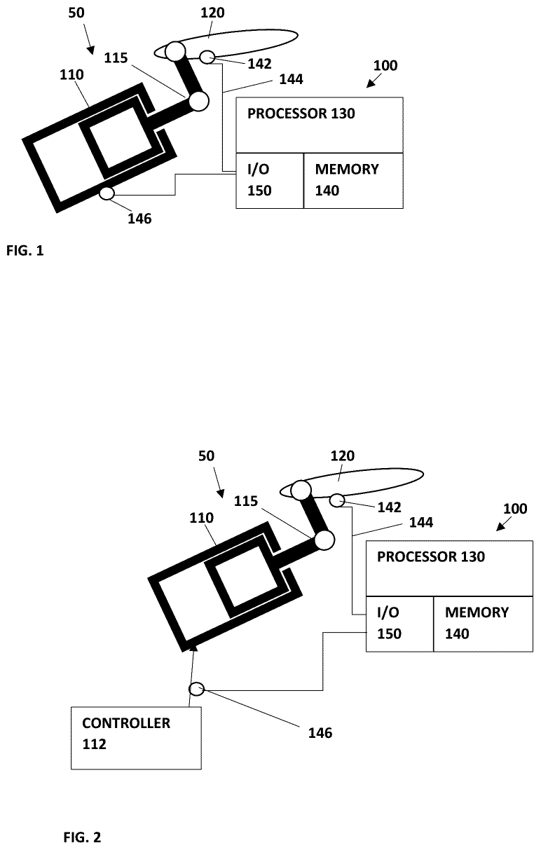

As indicated above, some embodiments of the present disclosure provide a system and method for monitoring an external system that includes at least one actuator and at least one object operated by the actuator. Reference is made to FIG. 1 exemplifying by a schematic illustration a system 50 according to some embodiments of the disclosure. System 50 includes at least one actuator 110 connected to at least one object 120 such that operation of the actuator 110 causes certain selected movement of the object 120. In this example, the object 120 is connected to the actuator 110 using on or more arms and pivots, generally at 115, configured to transmit operation of the actuator 110 toward the object 120. Generally, such mechanical system 50, may operate periodically and frequently and certain elements thereof may be subject to fault that may lead to reduced performance and up to failure in proper operation.

To this end, embodiments of the present disclosure provide a monitoring system 100 configured for monitoring operation of system 50. Monitoring system 100 includes at least one processor 130 and memory 140 that may represent a processor and memory circuitry (PMC). The processor 130 and memory 140 may be operatively connected to an I/O interface 150 for performing data input and/or output operations. System 100 is configured to provide processing functions necessary for operation as further detailed hereinbelow and may be configured to execute one or more selected functional modules in accordance with computer readable instructions implemented in the memory 140 and/or transmitted through the input interface 150. According to some embodiments, the at least one processor 130 may be a central processing unit (CPU) Graphic processing unit (GPU), a Tensor Processing Unit (TPU), a microprocessor, an electronic circuit, an Integrated Circuit (IC) or other processing units. Memory 140 may be a hard disk drive (HDD) solid state drive (SSD), a Flash disk, a Random Access Memory (RAM), a memory chip, or other data storing units. Generally, PMC may be associated with cloud processing utility and operate in communication with one or more remote processing and/or storage utilities.

According to some embodiments, the monitoring system may store various data types in the memory 140 for various uses. For example, the monitoring system may operate for storing copies of all input data for further inspection and quality control. Additionally, computer readable instructions may be stored at the memory 140 and executed for operation of the at least one processor 130. Additionally, the system may store data on determined relationship between actuator operation and object response in the form of histogram table, in the form of a transfer function and/or in the form of machine learning model. Additional stored data may be associated with potential failure modes, possible variations in transfer functions and correction route associated with varying actuator operation, and any type of data used for proper operation of the monitoring system 100. In some embodiments, the monitoring system 100 may be connectable to a remote storing unit via communication path and configured to transmit selected stored data to remote location for storing and/or further processing. For example, collected input data may be transmitted to a remote processing for training and/or updating machine learning model, while the machine learning model may be stored in memory 140 for use in monitoring of the complex system.

The monitoring system 100 is configured for receiving input data including at least a first input data 146 indicative of operation of the actuator 110, and at least a second input data 144 indicative of response of the object 120 to operation of the actuator 110. Monitoring system 100 is configured for processing the input data and determining a relationship between actuator 110 operation and object's 120 response, and to generate output data indicative of quality of the response of the object 120. According to some embodiments, monitoring system 100 may provide output data via I/O interface 150 to an external system that can process the data and determine further actions for maintenance and/or control operations based on the output data. Additionally, or alternatively, monitoring system 100 may include one or more alert indicators, such as LED light source and/or speaker, for generating output alert in case of identified faults within system 50. In some further embodiments as described in more details below, monitoring system 100 may be connected to one or more controllers of system 50 to provide output data indicative of variation in operation of system 50.

According to some embodiments, one or more of the first 146 and second 144 input data may include image data such as one or more images indicative of the respective one of the actuator 110 operation and response of the object 120. Accordingly, processor 130 may include selected image processing functions for analyzing input image data and determining, based on the one or more images, data indicative of one or more movement parameters. Such movement parameters may include location of one or more components in the image, variation in location of one or more components two or more image data pieces, speed of movement of the object, acceleration of movement, direction of movement, etc., wherein the one or more components relate to components of object 120 and/or object 120 itself.

In some further embodiments, the first input data 146 may include input signal indicative of operational instructions transmitted to the actuator 110, and the second input data includes one or more images depicting movement of the object 120 in response to operation of the actuator 110. Additionally, or alternatively, the first input data 146 may include one or more images indicative of operation of the actuator 110. In some embodiments, monitoring system 100 may be connectable, or include one or more optical sensors 142 positioned to collect optical data on the respective one of object 120 and actuator 110. Optical sensor 142 may be a photodiode, camera, infrared camera, CCD, CMOS, lidar. or any other optical sensor capable of detecting electromagnetic radiation of selected one or more wavelength ranges. The optical sensor(s) 142 may be positioned at a selected location to collect optical (e.g., image) data indicative one or more movement parameters of the object 120.

According to some embodiments, the term “image data” or “image(s)” as used herein relates broadly to various types of optical data that can be used to determine one or more movement parameters of the object (and/or actuator). It should be noted that image data is according to some embodiments data collected by an optical sensor operable is a selected wavelength range including visible spectrum, infrared, UV, or other wavelength range. First and/or second input data may include one or more images, e.g., images frames collected at different times indicating movement, and/or one or more image frames collected from one or more different perspectives of the object 120 and/or actuator 110 enabling analysis of range of motion of the controlled component.

It should be noted that according to embodiments of the present disclosure, any selected number of sensors may be used to collect and provide the first and second input data, or any additional input data that may be used. Such sensors may include optical sensors, proximity sensors, current sensors, voltage sensors, magnetometer, vibration sensors, acoustic/sound sensors, or any other suitable sensor.

The monitoring system 100 is configured to process the first 146 and second 144 input data and determine a relationship between actuator 110 operation and object 120 response. Typically, the monitoring system may generate output data indicative of health of the system 50, indicating typical relationship between actuator 110 operation and object 120 response. The monitoring system 100 may further store data on typical relationship, and if at any time the input data indicates a variation from the typical relationship, the monitoring system may generate an alert indicating variation in operation of system 50.

For example, in some embodiments, the monitoring system 100 may determine a transfer function indicating a relation between selected operation of the actuator 110 and response of the object 120. The monitoring system 100 may be adapted for storing data on determined transfer function at the memory 140 thereof and may utilize the stored data on the transfer function for determining variations in response of the object, that may indicate wear, fault and/or failure.

For example, the at least one object 120 in FIG. 1 may be a wing or a moveable portion of a wing, such as an aileron, an elevator, or a rudder. Further actuator 110 may include a motor (e.g., electric motor), piston or other actuator, and may include one or more bearings, buts, ball screws and one or more additional elements.

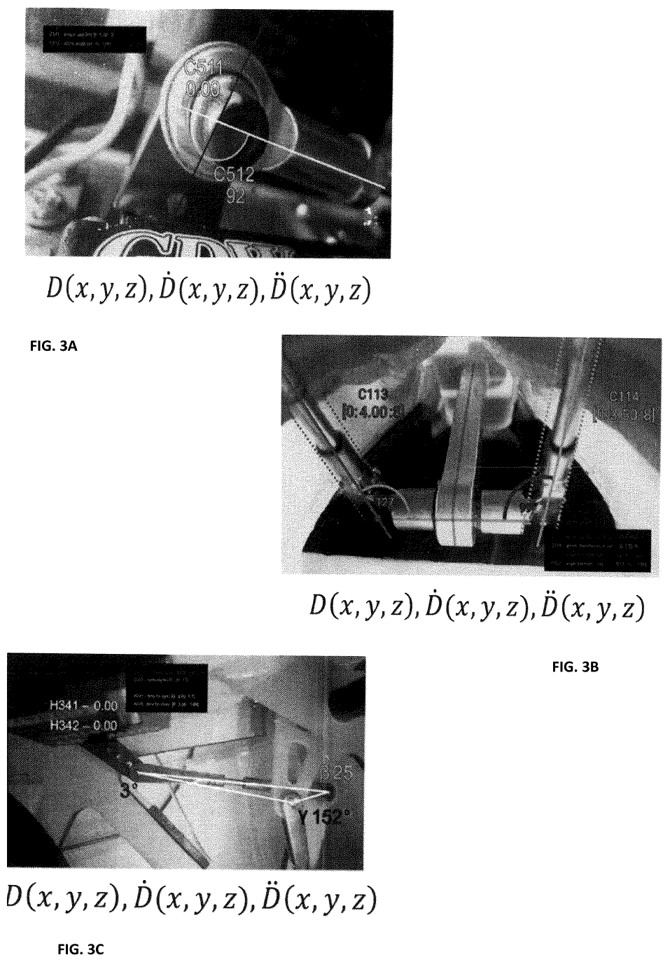

As indicated above, the first input data 146, may be obtained by monitoring operation of the actuator 110 using one or more sensors as indicated above. Alternatively, or additionally, the first input data may be input signal indicative of operation signals transmitted to the actuator 110 from a respective controller 112. FIG. 2 illustrates complex system 50 and respective monitoring system 100 and exemplifying controller 112 transmitting operational instructions transmitted to actuator 110 according to some embodiments. Operational instructions transmitted to the actuator 110 optionally represent desired actuation, and accordingly desired action performed on the object 120.

The use of first input data 146 indicative of operational instructions transmitted for operation of the actuator 110 may be beneficial for various systems where the actuator may be placed within a closed compartment and is not directly accessible. Further, this may enable detection of actuator 110 related faults as described further below, and differentiation between required actuator maintenance over actuation transmission line 115 maintenance or object 120 maintenance.

Generally, in some embodiments, one or more additional, e.g., external, forces may act on the at least one object 120, in addition to operation of actuator 110. For example, in the case of wing or a moveable portion of a wing, such as an aileron, an elevator, or a rudder, the object 120 may be subject to wind forces and air pressure variations. Accordingly, the system 100 may operate to determine data on relationship between actuator operation and object's response, while considering allowed variation range associated with varying external conditions, determining variation in actuator operation to obtain desired response from the object 120 and providing corresponding operational data to the actuator 110. However, if response of the object is determined to vary from typical accepted response, system 100 may operate to generate an alert indicating possible failure and suggesting maintenance and optionally a compensation command.

As indicated above, according to some embodiments, monitoring system 100, and the PMC thereof, are operable for receiving at least first and second input data, and for processing the first and second input data to determine relationship between actuator operation provided in the first input data, and object response provided in the second image data. The monitoring system 100 may utilize the determined relationship to determine a transfer function describing desired response to the object 120 to selected operation of the actuator 110. In case a variation is determined from a desired transfer function, e.g., transfer function that is determined repeatedly through operation of system 50 and stored in the memory 140 of the monitoring system 100.

As indicated above, the monitoring system 100 may be configured to receive input data, e.g., the second input data 144 indicative of object 120 response to actuation, in the form of one or more images. In some embodiments, monitoring system 100 may be adapted for processing one or more images for determining one or more movement parameters of an element. Optionally, determination of movement parameters is performed by following one or more marks and/or reference points on the element or its surroundings identified in sequential image data. Such one or more reference points or marks, may represent object 120, moving portion of actuator 110 or other moving elements in the system. Further, the monitoring system 100 may operate to use the one or more movement parameters to determine a relationship between actuator operation and object movement. Accordingly, movement patterns of object that are not related to the actuator 110, object 120 arrangement may be averaged, thus ignoring contribution of unrelated objects.

Additionally, monitoring system 100 may utilize processing of the received images and direct structure analysis, and for identifying possible fault and/or failure modes that may or may not be directly related to connection between actuator and object. In some embodiments, identifying possible fault and/or failure trend may enable locating the fault and/or failure mode and/or trend. For example, the monitoring system 100 may apply selected image processing for analyzing structure of the one or more objects 120 and/or actuator 110 as disclosed in WO2022/162663, PCT Application Nos. PCT/IL2023/050428, PCT/IL2023/050793, PCT/IL2023/050794, PCT/IL2023/050795, PCT/IL2023/050624, and/or provisional application No. 63/435,390 disclosed herein by reference as if fully disclosed herein.

According to some embodiments, monitoring system 100 may utilize image processing for determining structure and structural features of the one or more objects 120, and or actuator 110, and determine variation in structure, color pattern, and/or response of the object to actuator operation, that may be associated with one or more failure modes. More specifically, the monitoring system may operate to determine color variations, shape variations, corrosion, cracks, loose features, or any physical structure variation of the one or more objects 120 and/or actuator 110. Detection of physical variations may provide indication on faults in the system prior to degradation of operation efficiency and variation in transfer function of the controlled object.

For example, in some embodiments, the present disclosure may provide for determining one or more possible failure modes such as: at least one of a change in dimension, a change in position, a change in color, a change in texture, change in size, a change in appearance, a fracture, a structural damage, a crack, crack size, critical crack size, crack location, crack propagation, a specified pressure applied to the machine or the component thereof, a change in the movement of one component in relation to another component, an amount of leakage, a rate of leakage, change in rate of leakage, amount of accumulated liquid, a change in the amount of accumulated liquid size of formed bubbles, drops, puddles, jets, or any combination thereof. According to some embodiments, the system of the present disclosure may operate to determine such possible failure modes in accordance with variation in one or more of dimension, structure, one or more structural features, color, consistency, flow variation (e.g., due to leaks), continuity of the object based on image analysis thereof.

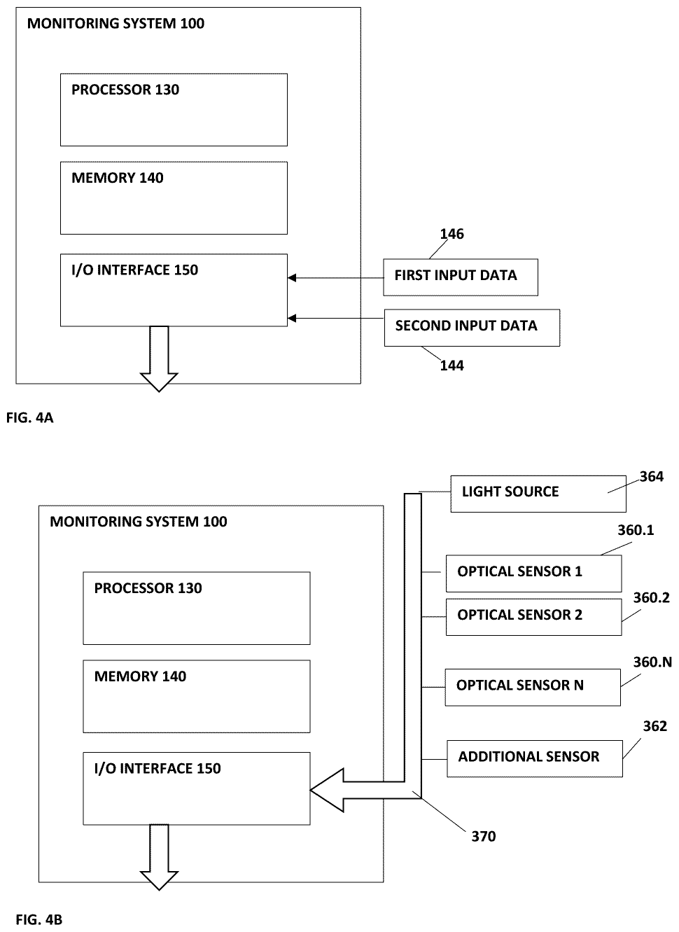

Image processing providing data indicative of range of motion of one or more objects according to some embodiments is exemplified in FIGS. 3A to 3C. FIGS. 3A to 3C exemplify images including at least a portion of a moveable object and one or more stationary reference positions. In some embodiments, image analysis may utilize determining one or more reference points within one or more images and determining location of the reference points with respect to stationary reference positions or with respect to each other. For example, one or more stationary reference positions may relate to frame or axles holding one or more objects, wherein one or more moving points may be determined based on features of the controllable object being operated by the actuator. The image analysis may utilize determining relative location between the stationary reference positioned and moving features of the object to determine location variations and thus movement of the object.

In some embodiments, the image analysis may further include determining one or more movements, being straight or curved lines, extending from respective one or more reference positions toward selected positions on the moveable object. In accordance with generally fixed location of the optical sensor (e.g., camera) that provides the images, variation in location of reference points, as well as angles and/or length of one or more curves determined within the image(s) may indicate level and direction of movement of the object. It should be noted that determining one or more curves may optionally utilize virtual lines, and processing within the at least one processor, and typically there is no actual line/curve drawing on the images.

In some additional embodiments, the input data may include two or more images collected at two or more different times through the period of operation of the actuator. This enables determining one or more movement parameters based on variation between the two or more images. Processing the images for detection of one or more elements and determining variation in the element's location between images (e.g., by determining one or more reference points, marks, or features associated with the element) enables determining variation in location, speed and/or acceleration of the object in response to actuator operation. Further, in some embodiments, the monitoring system 100 may utilize processing of the input image using one or more models, for determination range of motion of components in the image. In response to detection of relationship between movement detected in second input image data, indicative of object movement, and first input data indicative of operation of the actuator, the monitoring system 100 may determine within the image, elements that are associated with the object 120, over additional elements that me be moving in the images.

As indicated above, the monitoring system may utilize image processing of one or more images provided in accordance with the first and/or second input data, to determine one or more movement parameters. Such movement parameters may indicate operation of the actuator 110, when first input data includes one or more images, and/or movement of the object in response, when second input data includes one or more images. Such movement parameters may include data obtained via image analysis, e.g., determining relative location between features and/or using curves determined between features as exemplified in FIGS. 3A to 3C, detection of reference points, marks, or features on an element or object, object variation analysis, etc. In some embodiments, the image processing may operate to determine movement parameters such as translation (movement distance) with respect to selected location, direction of translation, rotation with respect to a selected orientation, acceleration, structural deformation (e.g., in view of force applied by the actuator and/or due to braking of other failure conditions), as well as speed and acceleration associated with range of movement between images collected at different times (frames). Additional data that can provide indication of at least one of actuator operation and/or object movement, may be provided as indirect data, such as data obtained by one or more additional measurement units, and/or electronic data. For example, input voltage, transmitted current, transmitted power, current frequency, and more, may provide input data indicative of actuator operation, and may in some embodiments also be used to provide input data on expected object movement. Further, one or more additional sensors may be used to provide the first and/or second input data. For example, such one or more sensors may be installed in the actuator's environment to provide first input data indicative of actuator operation. Exemplary additional sensors may include current sensor, voltage sensor, range sensor, weight sensor, temperature sensors, vibration sensors, etc.

As indicated above, the monitoring system 100 according to some embodiments of the present disclosure may operate to determine a relationship between actuator operation and response of a respective object. In some embodiments, the monitoring system may store data on the determined relationship in the form of a model (e.g., transfer function, machine learning model etc.) describing object response to actuator operation, in the memory thereof, and may use the stored model for evaluation the health of the system 50 being monitored. Accordingly, in response to new first and second input data, the monitoring system may determine if the received new first and second input data indicate that the object's response to actuator operation is within acceptable limits of the model, or if the response differs from desired response.

It should be noted that methods and system of embodiments of the present disclosure may utilize collection of first and second input data pieces at a selected sampling rate. for example, the monitoring system 100 may operate to obtain first and second input data from respective one or more sensors at sampling rate between 1 Hz and 10 Hz, 10 Hz and 100 Hz, 100 Hz and 1 KHz, 1 KHz and 50 KHz. In some embodiments, the sampling rate may be lower than 1 Hz. In some embodiments, the sampling rate may be in a range between 30 frames per second (FPS) and 240 FPS. Such sampling rate may be suitable for collection of image data. However, it should be understood that sampling rate between 30 FPS and 240 FPS may be considered as rate between 30 Hz and 240 Hz given that each frame is a sampled data piece.

It should be noted that sampling rate of sensing may be determined in accordance with rate of operation of the actuator 110 and controlled object 120. According to some embodiments, sampling rate as described herein relate to sampling rate of one or more sensors. In some embodiments, the one or more sensors include one or more optical sensors and respective first and/or second input data relates to one or more images, the sampling rate may relate to frames per second (FPS), accordingly, sampling rate of 1 Hz relates to 1 frame per second, etc. Further, in some embodiments of the present disclosure, one or more of the first and/or second input data may include sensing data other than image data.

In some embodiments, the monitoring system 100 may utilize a machine learning module for processing the first and second input data. Such machine learning module may be in the form of a neural network having one or more layers, deep neural network, or any other machine learning topology. In some embodiments, the monitoring system may operate first at a training mode, processing input data to determine a machine learning model and respective indicators. In some embodiments, the monitoring system may generate machine learning model and generate output signal indicative of any variation of the model, requesting the variation to be checked and verified. After processing of sufficient data, and determining model, the monitoring system may utilize one or more selected, or predetermined thresholds, where variation in object response that exceeds the selected respective threshold, the system may generate an output alert indicating possible malfunction that may require maintenance. In some embodiments, the use of machine learning tools may enable detection of fault and/or failure in further additional elements, other than the actuator 110 and controlled object 120. Failure in such further elements may cause variation in the first and second input data, while not directly be visible from relationship between them.

The use of machine learning may further enable determining location and type of detected failures. Machine learning analysis of actuator operation and response of controlled object may provide output data indicative of failure being within the actuator, the controlled object, an interface between them and/or at a different element of the system.

It should be noted that training of the machine learning module may be supervised, e.g., by indicating proper operation and malfunction of the actuator-object system for various input data sets. Alternatively, the training of the machine learning module may be unsupervised, allowing the monitoring system to repeatedly process input data sets, determining relationship between actuator operation and the respective object with respect to varying conditions. Each set of first and second input data may be used to further train the machine learning models, as well as to identify possible variations from the model, and to determine if the variation indicates possible malfunction, and to generate respective alert. Further, training of the machine learning module may utilize data collected by one or more actuator-object systems having generally similar operation. For example, in the case of wing elements, collected data from various airplanes or models using similar wing construction may be used of training the machine learning module, thus enhancing data volume.

Generally, in some embodiments, the monitoring system may operate in a training mode based on selected set of training input data. Such training input data set may include a plurality of data pieces such including for example: a plurality of images indicative of the respective actuator-object system during period of operation, images indicative of the respective actuator-object system during period of non-operation, images indicative of object desired response and respective data indicative of operation of the actuator, input control signals, image analysis output data, or any other type of input data set indicative of known state of operation of the actuator-object system. Optionally, in some embodiments, the at least one processor 130 may operate for analysis of input data during operation period of the actuator 110 and object 120 set. Further, during idle period of the actuator 110 and object 120 set, the at least one processor 130 may avoid processing of the input data, and specifically processing of image data therein. The input data may be input continuously from the optical sensors but not all data will be analyzed by the monitoring system 100. Image data collected during idle periods may be discarded or may be exported by the monitoring system to external systems (e.g., to an external controller) and/or for external storage (e.g., to cloud storage) for reference as described in more detail below.

Further, in some embodiments, the monitoring system may operate in a training mode where all collected input data in processed, and in monitoring mode, where input data during idle period may be maintained and stored. However, to save processing resources idle input data may not be directly processed and analyzed. Accordingly, the monitoring system, when operated in monitoring mode may analyze input data collected during operation period, i.e., when the actuator received operational command to actuate certain object operation.

As used herein, according to some embodiments of the present disclosure, the term “image data” or “image” may relate to any output of one or more optical sensor, including images, mapping of sensor output with respect to selected dimension (time, length, width), as well as data obtained by processing one or more images (for example to format the images into a data format suitable for the processing circuitry, to adjust contrast and/or brightness in the images, compensate for optical sensor vibration, etc.).

According to some embodiments of the invention, the image data includes images of components such as the actuator 110, controlled object 120, and/or parts thereof. Optionally, the image data also visualized other components (e.g., other elements such as static or passive components, surroundings where the actuator and object are operating in, a machine encompassing the actuator and object being monitored is part of, etc.).

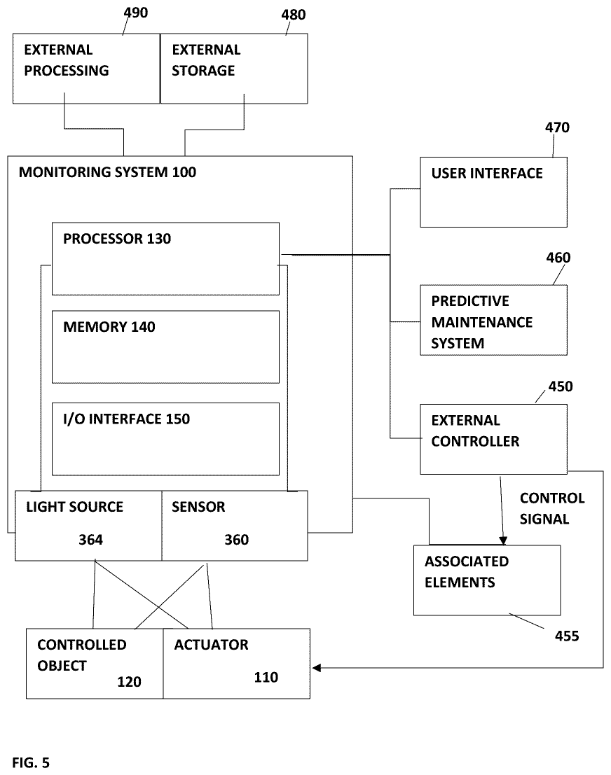

Reference is made to FIGS. 4A and 4B illustrating simplified block diagrams of a monitoring system 100 according to some embodiments of the present disclosure. As indicated above, the monitoring system 100 is adapted for monitoring a complex system utilizing input data indicative of operation of at least one actuator and response of at least one moveable object. FIG. 4A illustrates a monitoring system 100, where the system includes at least one processor 130, memory 140 and I/O interface 150. The processor may be any type of processor capable of executing selected computer readable instructions, which may be pre-stored in the memory 140 and/or transmitted through the I/O interface 150 from a remote system or vie user interface. Further, the system 100 may include a selected number of processors 130 and may include one or more additional electronic circuitry. Processor(s) 130 may include one or more of a Central Processing Unit (CPU), a Graphic Processing Unit (GPU), a Tensor Processing Unit (TPU), a microprocessor, an electronic circuit, an Integrated Circuit (IC) or the like.

System 100 is configured for receiving at least first 146 and second 144 input data indicative respectively of operation of at least one actuator and response of at least one corresponding object. Typically, the second input data 144, indicative of the at least one object may include one or more images depicting at least a portion of the at least one object. The at least one processor 130 is configured to receive the first and second input data and may also store the input data at the memory 140 for additional use and for reference. The processor 130 is further configured to process the input data for determining relationship between the first and second input data, and to determine variation of desired relationship if occur.

As indicated above, one or more of the first 146 and second 144 input data may include image data, accordingly, the at least one processor 130 may operate to perform image processing for identifying one or more element or object in the input images and determine one or more movement parameters of the element (e.g., based on one or more reference points, marks, or features) and use data on movement parameters of element in the one or more images to determine a relationship between movement in the second input data (typically object movement) and operation of the actuator in the first input data.

Furthermore, first and second input data, or any standalone data piece being a portion of the first and second input data, may include a time stamp indicating time of recording of the respective data pieces. The use of time stamp for data pieces enables the monitoring system 100 of the present disclosure to determine relation and causality between data pieces, indicating that certain movement of the object detected in second input data 144 is caused by operation of actuator that is indicated in first input data 146. Time stamps of input data may also be used to determine rate of response of the object, speed, acceleration thereof, and other time varying parameters. For example, a slow response of a controlled object, may indicate a fault in the controlled object or actuator.

It should be noted that the first input data may include input signal indicative of operational commands transmitted to the actuator, and/or data indicative of operation of the actuator. Such data may be in the form of one or more images or other data type, such as data indicative of length variation of an external portion of an actuator piston, rotation data on actuator rotation motor, etc. Additionally, the second input data may preferably include one or more images indicative of movement of at least one object moveable by the actuator. Second input data may also include one or more additional data elements such as data collected from one or more sensors positioned and operated to sense movement of the at least one object.

In some embodiments, after determining one or more movement parameters by image processing, the at least one processor 130 may operate to determine relation between data pieces indicative of actuator operation in the first input data 146, and the one or more movement parameters indicative of object movement and optionally additional data elements indicative of the object in the second input data 144. As indicated above, such relationship may be used to describe a transfer function of the object, may be used for training of a machine learning model, and may be used to generate set of rules on operation of the complex system. Additionally, to generating and/or updating transfer function, machine learning model and/or set of rules, the at least one processor 130 may be operable for determining variations from desired response of the at least one object. Upon determining a variation between desired response and actual response of the at least one object that exceeds a selected or predetermined threshold, the at least one processor 130 may act to generate an alert and transmit the alert through the I/O interface 150 to an operator.

It should be noted that processor 130 may also perform other tasks, such as storing image data to memory, providing a graphical user interface (GUI) to a user, processing inputs from the GUI and/or other input/output means and exporting data to an external system (e.g., a controller of the monitored system, a remote computing platform and/or a predictive health maintenance system).

Further, in some embodiments, the monitoring system 100 and its one or more processors 130 may be in communication with one or more optical and/or non-optical sensor(s) using wireless communication (e.g., Bluetooth, cellular network, satellite network, local area network, etc.) and/or wired communication (e.g., telephone networks, cable television or internet access, and fiber-optic communication, etc.). This is generally exemplified in FIG. 4B illustrating monitoring system 100 as exemplified in FIG. 4A, including an arrangement of optical sensors 360.1 to 360.n and one or more additional sensors 362 connected via a communication bus 370 to transmit data to I/O interface 150 of the system. In some embodiments, the monitoring system 100 may also be connectable or connected to one or more light sources 364 positioned to provide selected illumination conditions to the one or more optical sensors by illuminating one or more portions of the complex system being monitored.

According to some embodiments, optical sensors 360.1-360.n may include one or more cameras. According to some embodiments, optical sensors 360.1-360.n may include one or more electro-optical sensors configured for detection or location, range velocity or one or more other movement parameters. According to some embodiments, optical sensors 360.1-360.n may include any one or more of a charge-coupled device (CCD), a light-emitting diode (LED) and a complementary metal-oxide-semiconductor (CMOS) sensor (or an active-pixel sensor), a photodetector (e.g., IR sensor or UV sensor), a distance detection sensor (e.g., Lidar) or any combination thereof. According to some embodiments, optical sensors 360.1-360.n may include any one or more of a point sensor, a distributed sensor, an extrinsic sensor, an intrinsic sensor, a through beam sensor, a diffuse reflective sensor, a retro-reflective sensor, or any combination thereof.

In some embodiments, the one or more sensors, including optical sensors 360.1-360.n and additional sensors 362 may be independently operable sensors having internal local controller. According to further some embodiments, the at least one processor 130 of monitoring system 100 may be operable for controlling operation of the sensors. According to some embodiments, the at least one processor may be configured for controlling one or more operation parameters such as: sampling rate, sampling frequency, exposure time, exposure rate, field of view, and other sensing parameters. Additionally, the at least one processor may be configured to selectively turn sensors between ON and OFF states, e.g., for power saving when the respective complex system is no operational.

Further, to operate the one or more optical sensors 360.1-360.n, the sensors may be coupled, or associated to one or more lights sources. The at least one processor 130 of monitoring system 100 may be operable for controlling the one or more light sources 364, to provide selected illumination conditions. For example, the sensors may be coupled to one or more light sources 364 where each light source illuminates at least a portion of the mechanism. Optionally, each light source is focused on a specific component or reference point, which may enable reducing the required intensity of the light, while allowing collection of image data indicative of movement parameters of the object. The one or more light source s may be positioned for illuminating the object, and/or the actuator, to provide first and/or second optical input data.

In some embodiments, the at least one processor 130 may further control wavelength of illumination within a range of wavelength that can be provided by the respective light sources 364. For example, the one or more light sources 364 may include one or more LED arrangements carrying a selected number of LEDs having different emission wavelengths. The at least one processor may operate to determine which of the LED is operated, to thereby vary wavelength and/or illumination temperature. In some other embodiments, illumination conditions may be determined by an operator.

Further, selected illumination wavelength range may provide various imaging conditions and enable detection of different faults or potential failure types. For example, illumination by polychromatic visible wavelength range may illustrate color variations due to rust. Illumination with selected ultraviolet wavelength may be used to detect sparks in the image, cracks in metaling elements and other physical faults in the system.

In some embodiments, variation of illumination conditions, typically by controlling the one or more light sources 364, the monitoring system 100 may selectively vary imaging conditions. This may be used to improve or vary characteristics such as image brightness, sharpness, shading, and other image characteristics and to adjust imaging conditions for image processing actions required to detect one or more elements or objects in the image and to determine one or more movement parameters therefrom. Alternately or additionally, a light source may be adjusted to case detecting faults and/or surface defects and/or structural defects by increasing shadows that highlight such areas.

According to some embodiments, the one or more light sources may be any type of light source including for example: a light bulb, a light-emitting diode (LED), a laser, an electroluminescent wire, and light transmitted via a fiber optic wire or cable (e.g., from an LED coupled to the fiber optic cable). Other types of light sources may also be suitable.

In some embodiments where the monitoring system 100 may control operation of the one or more light source, controlling the one or more light source may include control over one or more of the following functions: illumination field of view, illumination direction, illumination duration, illumination frequency range, intensity of illumination, selected temporal illumination pattern (e.g., illumination in pulses possibly to create a strobe light effect or provide gated imaging conditions), continuous illumination, synchronization of illumination, and any other illumination parameter. Generally, in some embodiments, the one or more light sources may operate in selected one or more visible ranges, infrared wavelength range (IR), near IR, ultraviolet wavelength range or any other wavelength range.

According to some embodiments, the one or more light sources 364 may include one or more strobe light source or a light source configured to illuminate in short pulses. According to some embodiments, the strobe light source may be configured to emit strobing light without use of a shutter (such as a global shutter, rolling shutter, shutter, or any other type of shutter). Using a strobe light may be particularly useful for monitoring potential failure modes of fast-moving objects, for example for identifying additional failure modes other than range of motion.

In some embodiments, as indicated above, the monitoring system 100 and the at least one processor 130 may operate the one or more light sources 364 to provide selected illumination conditions based on a predefined or selected algorithm. Optionally, the light source is controlled in accordance with the environment of the complex system being monitored to compensate for environmental illumination conditions. For example, the light source may be turned on during nighttime operation and turned off during daylight.

When controlling operation of the one or more light sources 364, the monitoring system 100 may operate dynamically to vary illumination conditions in accordance with varying operation requirements. For example, by using different light sources for illumination different regions of the complex system. For example, the light source 364 may utilize a central light emitter coupled with an arrangement of optical fibers. In some embodiments, controlling operation of the light source may be performed by controlling which optical fiber directs emitted light, thereby illuminating selected regions of the complex system in accordance with selection of coupling emitted light into selected optical fibers at different times.

According to some embodiments, the one or more optical sensors 360.1 to 360.n may include one or more lenses and/or a fiber optic sensor. According to some embodiments, optical sensors 360.1-360.n may include a software correction matrix configured to generate an image from the optical sensor output signal. According to some embodiments, the one or more optical sensors 360.1 to 360.n may include a focus sensor configured to enable the optical sensor to adjust its focus based on changes in the obtained data. According to some embodiments, the focus sensor may be configured to enable the optical sensor to detect changes in one or more pixels of the obtained signals. Optionally, the changes in the focus may be used as further input data for processor 130. It should be noted that optical elements, such as lenses, reflectors, as well as the sensors, may be selected in accordance with wavelength of illumination used. For example, lenses used by the one or more optical sensors may be formed of selected materials and/or carry selected coating to provide desired optical performance in accordance with wavelength range being used. Further, the one or more optical sensors 360.1 to 360.n may be configured for detection of selected one or more wavelength ranges, and optionally provide color images, e.g., using Bayer and/or Bayer-like wavelength filter arrangement.

According to the exemplary configurations illustrated in FIGS. 4A and 4B, the monitoring system 100 may in some embodiments, be configured as a processing circuitry within a housing, including one or more wired and/or wireless communication ports for communication with one or more sensors, and optically with an external operation system. The system may be configured to be placed at selected locations, e.g., within a wing of flying vehicle, along a production line, or at any location where proper operation may be associated with at least one actuator operating to move at least one object. The monitoring system 100 provides monitoring to the operation of the complex system and may generate indications of proper operation when suitable. Upon detection a malfunction, the monitoring system may generate an alert.

Alternatively, the monitoring system 100 may utilize distributed processing, based on one or more processors and memory that may be arranged in selected one or more locations and utilize communication network between them. Further, in some embodiments, the present technique may be provided as computer readable software, loaded to existing management systems, and operating within one or more processors using time multiplexing and time sharing of processing resources.

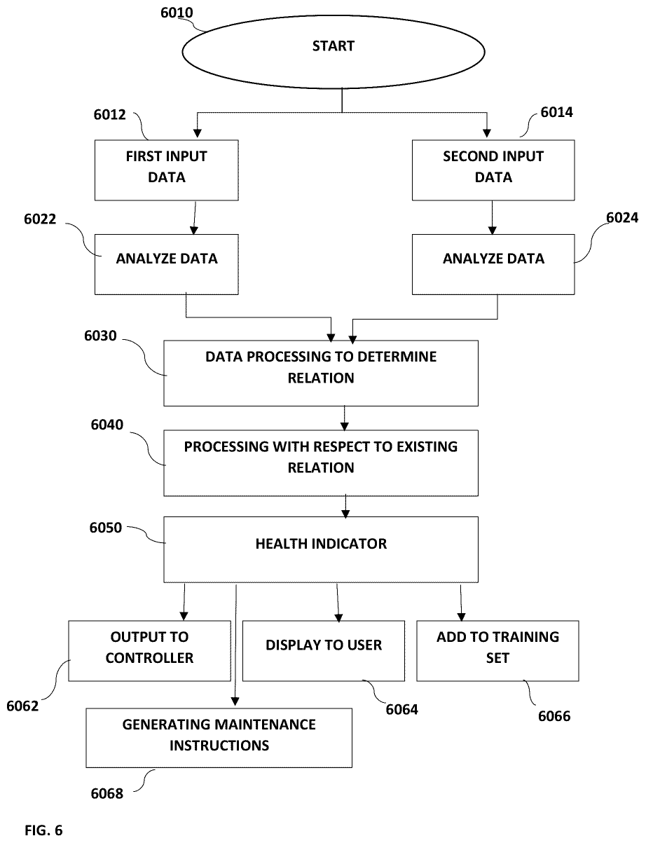

Reference is now made to FIG. 5, exemplifying monitoring system 100 by a simplified block diagram. As illustrated, monitoring system 100 may utilize one or more sensors 360, and may utilize one or more light sources 364 for collecting input data indicative of operation of a complex system including at least one actuator 110 and object 120 set. Monitoring system 100 includes at least one processor 130 and memory 140 operating as processing and memory circuitry. As indicated above, the one or more sensors 360 and light source(s) 364 may be a part of monitoring system or external elements connectable via selected communication path.

As indicated above, monitoring system 100 inputs data of at least one section of actuator 110 or controlled object 120 from the one or more sensors 360 providing at least first and second input data and operates to determine data on range of motion of the section or sections of actuator 110 or controlled object 120. In some embodiments, the first and second input data may be first and second input image data sets, where each image data set includes one or more images. This enables detection of one or more movement parameters in transverse directions with respect to point of view of the sensor 360. Using the input data, the monitoring system 100 operate to determine quality of response of the object 120 with respect to operation of the actuator 110, and generate output data indicative of health of the actuator 110 and/or controlled object 120, being associated with response quality of resulting from faults that are not directly associated with relationship of operation.

In some embodiments, the monitoring system 100 may utilize processing of movement parameters and range of motion to determine a relationship between actuator operation and object response as described above and determine quality of response in accordance with the determined relationship and/or variation from typical response.

As indicated above, monitoring system 100 may utilize one or more machine learning models describing proper relation between actuator operation and object response. To this end, the system may transmit the input data to an external processing unit 490 for training and generating a machine learning model. The trained machine learning model may be later stored at the memory 140 of the system allowing local processing of additional input data. Additionally, or alternatively, the system may utilize external storage 480 for storing machine learning model and respective input data. Monitoring system 100 may transmit input data including images, and/or processing data to the external storage 480.

Further, in some embodiments, the monitoring system 100 may include or be connectable to one or more additional external elements including for example one or more of user interface 470, predictive maintenance system 460, external controller 450 and/or one or more associated elements 455, described in more detail below.

Accordingly, in some embodiments, the monitoring system 100 obtains input data including at least first and second input data collected by one or more sensors 360. The processor 130 is operable for processing the input data to determine relation between operation of the actuator 110 and response of the respective object 120, in accordance with first and second input data. The processor 130 may utilize machine learning model, transfer function data or other data structures that represent proper relationship between actuator operation and object response in healthy system conditions. If the input data indicates healthy response of the object 120, the system may output an indicator of healthy response. If on the other hand, response of the object is determined to be outside of the range of healthy response, the monitoring system may generate output data requesting maintenance of actuator-object set or of the complex system being monitored.

Further, in some embodiments, the processor 130 may operate for processing and analyzing the input data, e.g., one or more images, to determine possible fault, failure modes and/or trend of failure modes based on the images and optionally other data such as environmental data. In some embodiments the processor may operate to determine a mode of operation that enable fixing the detected fault be operating the system to match response of the object. In some embodiments the at least one processor 130 may determine response that exceeds desired response based on two or more (or three or more) thresholds including a first malfunction threshold indicative of certain failure in the system that may require immediate attention for fixing, and a second threshold, generally lower, indicating smaller variation that may be compensated for or allow the system to proceed operation. Such smaller variations may be associated with slight fault and may indicate a need to replace one or more accuracy elements such as washers, bearings etc. In some embodiments the at least one processor 130 may determine response in accordance with different stages, e.g., three stages including: green indicating that the system operates as desired, yellow indicating that there is some fault, but the system can function—schedule maintenance, and red indicative that the system should stop operating immediately or a failure will occur.

In some embodiments, the at least one processor may also operate to determine one or more sub-threshold (or mini thresholds) relating to level of variation from desired operation and providing increased sensitivity for determining failure trend for various faults.

In some embodiments, in response to small variation in transfer function, the at least one processor 130 may generate output data indicative of operational instructions of the actuator 110, directed at varying actuator operation to obtain desired response of the object 120 in accordance with a corrected or updated transfer function.

Arrangement of the one or more sensors 360 and light source 364 when used is optionally based on configuration and accessibility to the actuator 110 and object 120 being monitored. As indicated above, the sensor 360 may include one or more optical sensor (e.g., camera, photodiode, etc.) positioned at a selected location relative to the object 120 to provide data indicative of variation in location and/or one or more movement parameters of the object. Similarly, in some embodiments, operation of the actuator may also be monitored using optical sensor. In some further embodiments, operation of the actuator 110 may be determined based on input signals indicative of operational commands transmitted for operation of the actuator 120. Further, in some embodiments, as indicated in FIG. 3B, the input data may be obtained using an arrangement of one or more sensors 360 including optical and optionally non-optical sensors.

In some embodiments, the at least one processor 130 may determine in accordance with first and second input data if the actuator 110 and object 120 are operating or standing still. During operation of the actuator 110 and object 120, the processor 130 operate for monitoring activity of the object 120 in response to operation of the actuator 110. This is while monitoring system 100 may operate in low energy mode while actuator 110 is not operating. In some embodiments, an operation indicator sensor may be used for determining data on activity of the actuator 110 and expected response of the object 120. In some other embodiments activity indication may be determined by analyzing input data including the first and second input data. For example, a blurred image may indicate that actuator 110 and/or object 120 are in motion while a clear image may indicate that actuator 110 and/or object 120 are static. In some further additional embodiment, monitoring system 100 may utilize input data indicative of operational commands operating the actuator 110, such that when the actuator received input commends for operation thereof, the monitoring system detects it and initiate monitoring. Alternatively, when no operational commands are transmitted to the actuator 110, the monitoring system may pause monitoring, e.g., maintain collection and storing of first and second input data, while pause processing such as image analysis. In some embodiments, pausing monitoring may include operation in a standby mode, and re-initiating processing in response to input signal indicative on operation of the actuator.

Optionally, in some embodiments, one or more images obtained by sensors 360 may be tagged with information on the operational status of the actuator 110 and/or the object 120 and/or additional associated elements. For example, such tagging may include tagging of image data indicative of object 120 using actuator input data, and external sensor data indicative of wind or other environmental conditions. In some other examples, first input data may be used as tag of second input data or vice versa. Such tagging may be used for machine learning purposes and/or for simplicity in data structures and communication.

As indicated above, in some embodiments, monitoring system 100 may be associated with an external controller 450 and may provide output indication data to the external controller. External controller 450 may analyze the received data and perform control actions on the actuator 110 and object 120 being monitored. For example, external controller 450 may be configured to vary actuator operation in response to shifts in transfer function being within a second threshold limit, e.g., indicating that small variation in actuator operation may be used to provide the desired response of object 120. Alternatively, or additionally, external controller 450 may operate selected maintenance operations in response to indication that such maintenance is necessary. External controller 450 may control actuator 120, object 120 and/or one or more associated element(s) 455 that may be part of the system being monitored. Such associated elements 455 may include one or more machine or vehicle containing the actuator 120, elements in the vicinity of actuator 120, elements connected to the actuator 120, controlled object 110 and or additional objects, and so forth. For example, in some embodiments, the external controller 450 may limit or prevent movement of object 120 in response to alert on failure from the monitoring system 100. Optionally, additional control actions may be performed taking into account the detected failure for controlling operation of the actuator

Optionally, in some embodiments, the monitoring system 100 may transmit output indicator including data indicative of quality of response of the object 120 to actuator operation 110 to a predictive maintenance system 460. Predictive maintenance system 460 may analyze the data contained in the indicator along with additional data such as previously received indicators, manufacturer specifications, operational information etc., and determine data on one or more maintenance operation that may be used to reduce risk of failure and prolonging lifetime of the system. Predictive maintenance system 460 may utilize data on time periods actuator 110 and/or object 120 are in operation, data on environmental conditions, data on previous maintenance operations, etc. Predictive maintenance system 460 may operate one or more maintenance modules and/or generate output data including maintenance instructions for actuator 110, object 120 and/or additional associated elements 455.

In some embodiments, output data may be generated including one or more classes of alerts in accordance with type of fault, failure trend and/or failure mode detected. For example, a first alert level may indicate a problem to be dealt with in routine maintenance, this may be a smaller problem that is not expected to progress very fast. A second alert level may indicate there is a problem that affects operation of the system, but it can compensate for by changing actuator control based on modified transfer function. A third alert level may indicate a problem that requires immediate attention and machine must stop to avoid fatal failure. And a fourth alert level indicates a serious problem, but such that the system can still operate using spare and/or back-up elements. Further, in some embodiments a fifth alert level may indicate that there is a problem that cannot be directly identified by the system. The use of selected number of alert level and the use of back-up and/or spare elements may enable continuous operation while monitoring for possible failures.

Additionally, in some embodiments, monitoring system 100 may operate to transmit indicator including data on relation between actuator 110 operation and object 120 response to user interface 470 for presentation. In some embodiments user interface 470 may be textual and/or graphical user interface (GUI). The indicator may provide operator/user with data on system health and indicate detected faults, failures, trends and/or modes of failure in actuator 110 and/or controlled object 120. In some embodiments, the indicator may provide data on detected fault, indicating one or more modes of action that may enhance the fault and increase a risk for failure. The indicator may thus include data on trend of fault, such as indicating one or more conditions and/or operations that are expected to result in failure. In some embodiments, the trend of fault may include data of fault progress speed and expected time in which such fault may lead to failure. Although in some embodiments, predictive maintenance system 460 may operate to perform certain maintenance operations or for rectifying an issue, e.g., by adjustment of actuator operation signals in accordance with modified transfer function, typically in various embodiments, a user's intervention may be required for actual maintenance operations. Accordingly, user interface 470 may be used to provide indication to users or operators on required maintenance operations and providing proper instructions as the case may be.

As indicated above, monitoring system 100 may utilize machine learning model for determining health status of actuator 110 and object 120 based on first and second input data. To provide low-cost monitoring, the system 100 may utilize processor 130 that is relatively low cost and simple. Such low-cost processor may be sufficient for determining response status; however, it may be insufficient for training and generating machine learning model. To this end, the monitoring system 100 may transmit input data to external storage 480 and to external processing 490. External processing unit 490 may be any type of processing unit located remotely and/or utilize cloud computing. Accordingly, external processing unit 490 may provide increased processing power supporting processing operation for training a machine learning model. External processing 490 may update the machine learning model based on various input data transmitted from monitoring system 100 providing updated training set for modeling the actuator 110 and/or object 120 operation using new input (e.g., image) data. The updated machine learning model may then be transmitted to memory 140 of monitoring system 100 for use by processor 130.

Optionally, the monitoring system does not transmit any input data to the external processing 490 during periods of time that actuator 110 and/or controlled object 120 are not in operation. Alternately or additionally, the monitoring system 100 may transmit input data, e.g., including image data to external processing 490 and storage 480 during idle period of actuator 110 and object 120, Such idle input data may be tags for use as baseline data for comparison with data collected captured during operation.

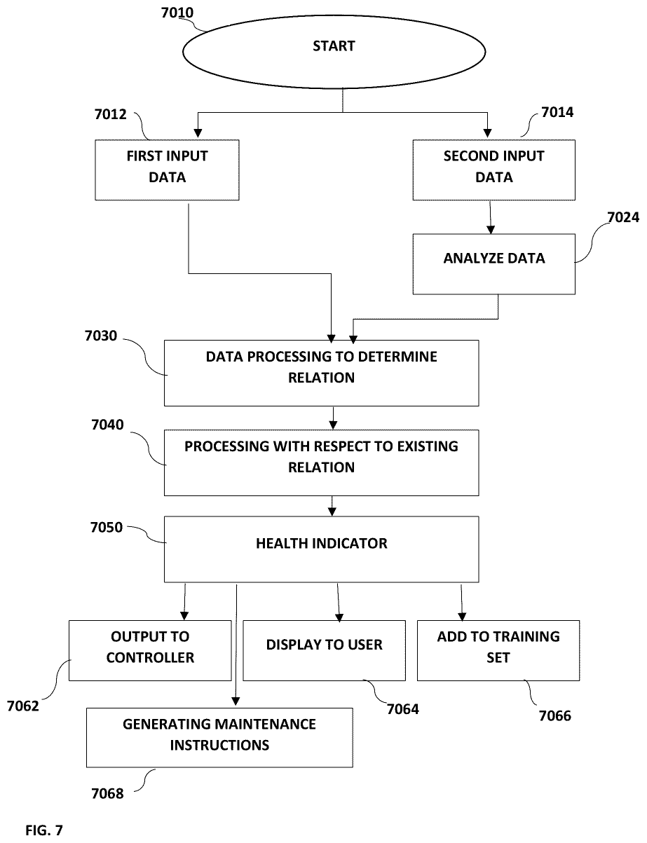

Reference is made to FIGS. 6 and 7 illustrating variations of methods for monitoring a system according to some embodiments of the present disclosure in the form of simplified flowcharts.

FIG. 6 illustrates a method according to embodiments of the invention including operation initiating 6010, and providing, e.g., by receiving from one or more sensors, first input data 6012 and second input data 6014 indicative respectively of operation of an actuator and response of a respective object. In this specific example, first and second input data may be in the form of image data, i.e., including one or more input data pieces obtained via an optical sensor. Accordingly, the method further includes analyzing the first and second input data 6022 and 6024 to determine data indicative of movement of the actuator and of the respective object. Analyzing the first and second input data may include various actions preprocessing, filtering, and segmentation of the first and second input data. For example, in embodiments where one or more of the first and second input data include one or more images, analysis may include detection of one or more elements (e.g., based on one or more reference points, marks, or features) in the first and second input data, identifying features, and performing any needed image processing action as the case may be.

Specifically, analysis of the image data may be used to determine one or more movement parameters. The movement parameters data is analyzed to determine correlation and a relationship therebetween 6030. In accordance with correlation and relation between the movement parameters and/or time frames in the first and second input data, in some embodiments the method further includes processing the correlation to determine variation from desire relation 6040. Such variation may be associated with various sources, and variations within acceptable range may be acceptable. To this end the method includes determining a health indicator 6050 indicating level of variation from acceptable relation, and optionally, a possibility of failure. Data on the health indicator, may be transmitted as output data to one or more of: controller 6062 for variation of actuator operation if needed, user interface 6064 to provide indication to a user or an operator on required operations and system status, to a machine learning utility 6066 for improved training and updating machine learning model if used, and/or to maintenance system including maintenance instructions 6068.

FIG. 7 illustrates a method according to some embodiments of the present disclosure, wherein first input data 7012 is operational data indicative of operation of the actuator. Accordingly, the first input data may be used to determine correlation and may undergo various analysis operation. For example, the first input data may be analyzed to determine expected actuator operation in response to the operational data. further, such analysis may include processing of the data indicative of operation of the actuator in accordance with expected transfer function, to determine expected object response, e.g., by translation, movement, rotation, and response rate. It should be noted that the embodiments of FIGS. 6 and 7 may be combined using both image and operational data of the actuator. Further, in some embodiments, certain input data on the object (second input data) may be direct data on movement parameters of the object that need not specific analysis prior to determining a relation.

In some embodiments, processing of the input data, being in the form of image data and/or as operational data may enable the system to determine one or more of fault location, trend of fault, expected failure location and/or time, and/or locations where maintenance may be required. This is by indicating a location of variation from desired response along the operation chain running between operational commands transmitted to the actuator, actuator operation, transmission of actuation to the object, and object movement.

Accordingly, the present disclosure provides a system and method for monitoring an external, typically complex, system including one or more actuators operable for moving one or more respective objects. The present technique is capable of learning operation response of the monitored system and identify situations of failure and need for maintenance in accordance with monitoring data.

It is to be noted that the various features described in the various embodiments can be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based can readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A monitoring system comprising:
at least one processor and memory circuitry and I/O interface adapted to receiving at least two input data pieces comprising at least a first input data piece indicative of actuator operation, and at least a second input data piece indicative of a selected object's response to said actuator operation; said at least one processor is adapted for processing said at least two input data pieces and to determine data indicative of health of at least one of said selected object or said actuator.

2. The monitoring system of claim 1, wherein said at least one processor is adapted for processing said at least two input data pieces and to determine data indicative of relationship between said selected object's response and said actuator operation, and determine data indicative of health of said selected object or said actuator in accordance with quality of relationship.

3. The monitoring system of claim 1, wherein said at least one processor is adapted for determining said data indicative of health of said selected object or said actuator based on said relationship between said selected object's response and said actuator operation, and wherein said data indicative of health comprises an alert if health of said selected object or said actuator is below a selected threshold.

4. The monitoring system of claim 1, wherein said second input data piece comprises one or more images indicative of said selected object's response to said actuator operation, said at least one processor is adapted for processing said one or more images to determine mechanical response of said selected object to said actuator operation.

5. The monitoring system of claim 1, wherein said at least one processor is adapted for determining based on said first input data piece data on desired response of said selected object.

6. The monitoring system of claim 5, wherein said at least one processor is adapted for determining based on said second input data piece data on one or more motion parameters of said selected object in response to said actuator operation.

7. The monitoring system of claim 6, wherein said one or more motion parameters comprise: range of motion, motion speed, acceleration, or motion direction of said selected object.

8. The monitoring system of claim 6, wherein said at least one processor is adapted to determine said data indicative of health of said selected object in accordance with a relation between said desired response and said one or more parameters of said selected object in response to said actuator operation.

9. The monitoring system of claim 1, wherein said first input data piece comprises at least one of: (i) one or more images indicative of operation of said actuator, (ii) operation data indicative of signal transmitted to said actuator and configured to cause operation thereof.

10. The monitoring system of claim 1, wherein said at least one processor is adapted for determining a transfer function being indicative of a relation between actuator operation and response of the selected object to said actuator operation, and to store data indicative of said transfer function in said memory, and for using stored data on the transfer function to determine variation in response of said object to said actuator operation.

11. The monitoring system of claim 10, wherein in response to determining said data indicative of health said selected object and said actuator being below said selected threshold, said at least one processor is further adapted for determining an updated transfer function, and for determining output instructions indicative of corrected operation of said actuator providing a desired response of said selected object.

12. The monitoring system of claim 1, wherein said at least one processor is configured for processing data on a relationship between said selected object's response and said actuator operation and if said relationship varies from a desired transfer function, said at least one processor is adapted for generating alert indication associated with one or more failure modes.

13. The monitoring system of claim 12, wherein said one or more failure modes comprise one or more failure types selected from the group of: corrosion, tear, crack, leakage, ice accumulation, structural deformation, surface deformation, corrosion, structural defects, mechanical defects, and flutter.

14. The monitoring system of claim 1, further comprising at least one sensor connectable to said input module and configured to provide sensing data indicating of at least one of said first or second input data pieces.

15. The monitoring system of claim 1, further comprising at least one optical sensor connectable to said input module and configured to provide image data comprising one or more images being at least one of said first or second input data pieces.

16. The monitoring system claim 1, configured to be associated with a complex system comprising at least one actuator and at least one object operatively connected to said at least one actuator such that operation of said at least one actuator causes a desired movement of said at least one object, and wherein said monitoring system and operable for generating one or more alerts in response to detection of quality of response being below a selected threshold.

17. The monitoring system of claim 16, further configured to determine a transfer function indicative of response of said at least one object to operation of said at least one actuator, determining an updated transfer function upon determining variation in response of said at least one object, and for generating output data indicative of updated operation instructions for operation of said at least one actuator in accordance with said updated transfer function.

18. The monitoring system claim 1, wherein said data indicative of health of said selected object and said actuator comprises an output signal indicative of at least of: indication of a need for system maintenance, maintenance instructions, indication of system failure, indication on updated actuator operation scheme.

19. A method for monitoring a complex system, comprising:
a. providing first input data indicative of operation of at least one actuator and second input data indicative of response of at least one object actuated by said at least one actuator;
b. processing said input data and determining data indicative of a relationship between response of said at least one object and operation of said actuator;
c. generating an output signal comprising at least one indicator of health of said selected object and said actuator.

20. A computer program product comprising a computer useable medium having computer readable program code embodied therein, the computer program product comprising computer readable program code for causing the computer to:
a. provide first input data indicative of operation of at least one actuator and second input data indicative of response of at least one object actuated by said at least one actuator;
b. process said input data and determining data indicative of a relationship between response of said at least one object and operation of said actuator;
c. generate an output signal comprising at least one indicator of quality of response of said at least one object to operation of said at least one actuator.
